(19) United States
(12) Patent Application Publication
(10) Pub. No.: US 2020/0067241 A1
(43) Pub. Date: Feb. 27, 2020

(54) Retractable Wall Outlet Extension

(71) Applicant: Anna Jones, Huntington Beach, CA (US)

(72) Inventor: Anna Jones, Huntington Beach, CA (US)

(21) Appl. No.: 16/113,219

(22) Filed: Aug. 27, 2018

(51) Int. Cl. H01R 13/72; H01R 35/02; H01R 27/00; H01R 25/00; H01R 13/73

(52) U.S. Cl. CPC H01R 13/72; H01R 35/025; H01R 13/73; H01R 25/006; H01R 27/00

(57) ABSTRACT

A retractable wall outlet extension for easily relocating a wall outlet includes an outlet housing having a cavity between a front side, a rear side, a left side, a right side, a bottom side, and a top side. An at least one outlet is coupled to the outlet housing within an at least one outlet aperture. A spool assembly comprises an axel coupled within the outlet housing, a spool rotatably coupled to the axel, and a tensioner spring is coupled between the spool and the axel. An extension cord has a proximal end coupled to each of the at least one outlets, is wound around the spool and through the cord aperture with a distal end having a plug. The extension cord has a wound position on the spool with the plug proximal the outlet housing and an alternate extended position with the extension cord extended through the cord aperture.

### CROSS-REFERENCE TO RELATED APPLICATIONS

Not applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to power extensions and more particularly pertains to a new power extension for easily relocating a wall outlet.

### BRIEF SUMMARY OF THE INVENTION

An embodiment of the disclosure meets the needs presented above by generally comprising an outlet housing having a cavity between a front side separated from a rear side, a left side separated from a right side, and a bottom side separated from a top side. The outlet housing has an at least one outlet aperture extending through the front side to the cavity and a cord aperture extending through the bottom side to the cavity. An at least one outlet is coupled to the outlet housing within the at least one outlet aperture. A spool assembly is coupled within the cavity of the outlet housing. The spool assembly comprises an axel, a tensioner spring, and a spool. The axel extends from the front side to the rear side of the outlet housing, the spool is rotatably coupled to the axel, and the tensioner spring is coupled between the spool and the axel. An extension cord is coupled within the cavity of the outlet housing. The extension cord has a proximal end coupled to each of the at least one outlets. The extension cord is wound around the spool and through the cord aperture of the bottom side with the distal end having a plug. The extension cord has a wound position on the spool with the plug proximal the outlet housing and an alternate extended position with the extension cord extended through the cord aperture. The cord is manually extended from the wound position to the alternate extended position by a user pulling on the distal end and unwinding the spool. The spool loads the tensioner spring as it unwinds, allowing the extension cord to return from the extended position to the wound position under the power of the tensioner spring.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a retractable wall outlet extension according to an embodiment of the disclosure.

FIG. 2 is a front elevation view of an embodiment of the disclosure.

FIG. 3 is a rear elevation view of an embodiment of the disclosure.

FIG. 4 is a side elevation view of an embodiment of the disclosure.

FIG. 5 is a cross-sectional view of an embodiment of the disclosure along line 5-5 of FIG. 2.

FIG. 6 is a cross-sectional view of an embodiment of the disclosure along line 6-6 of FIG. 5.

FIG. 7 is an in-use side elevation view of an embodiment of the disclosure.

FIG. 8 is an isometric view of an alternative embodiment of the disclosure.

FIG. 9 is a front elevation view of an alternative embodiment of the disclosure.

FIG. 10 is a rear elevation view of an alternative embodiment of the disclosure.

FIG. 11 is a side elevation view of an alternative embodiment of the disclosure.

FIG. 12 is a cross-sectional view of an embodiment of the disclosure along line 12-12 of FIG. 9.

FIG. 13 is a cross-sectional view of an embodiment of the disclosure along line 13-13 of FIG. 12.

FIG. 14 is an in-use side elevation view of an embodiment of the disclosure.

### DETAILED DESCRIPTION OF THE INVENTION

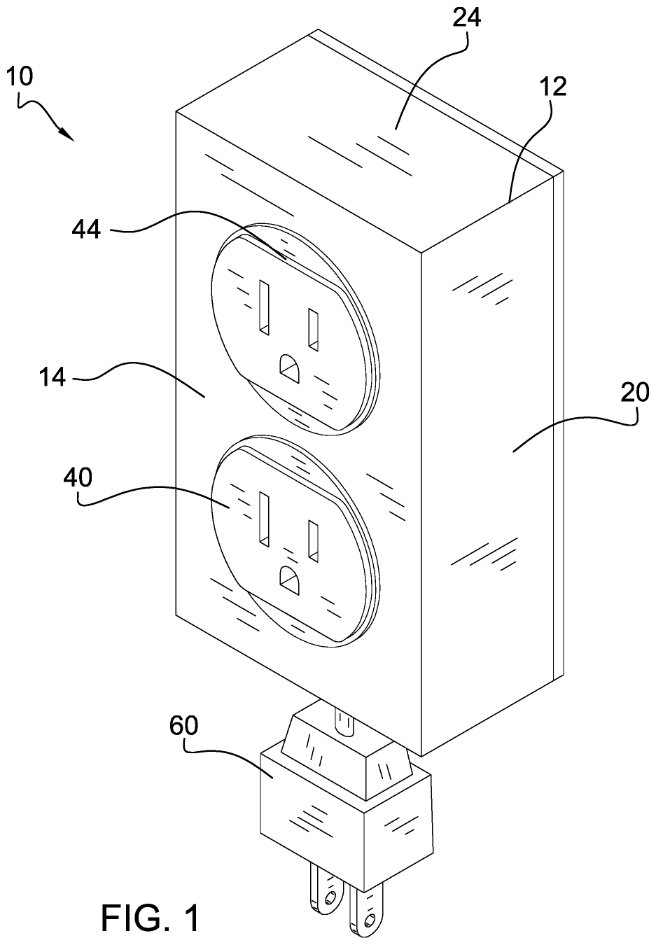

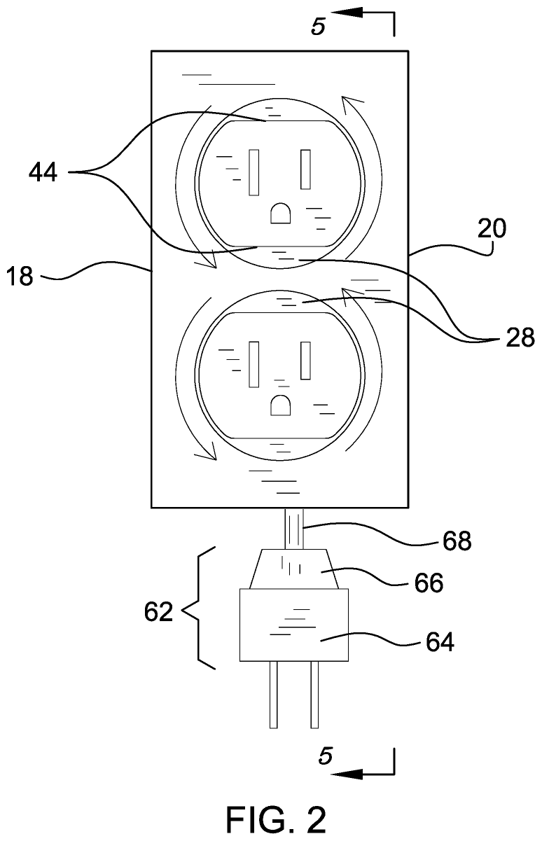

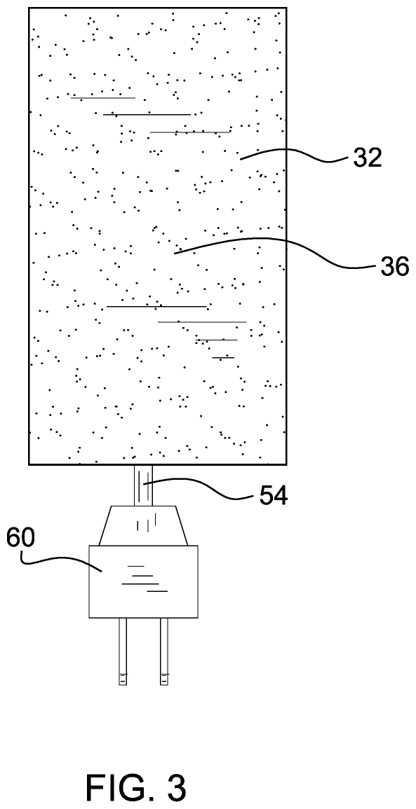

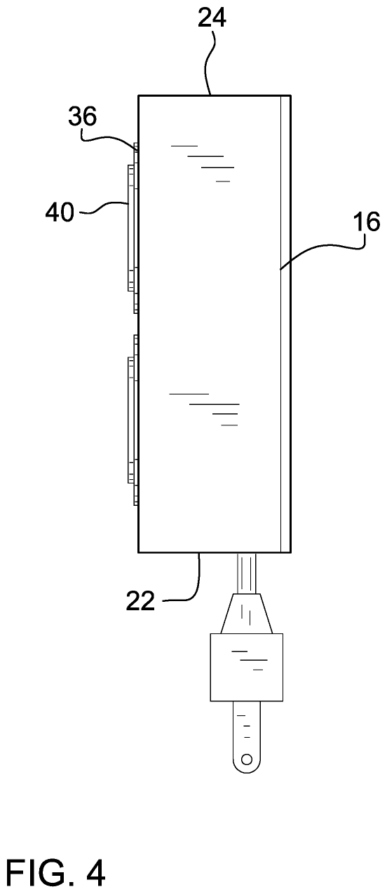

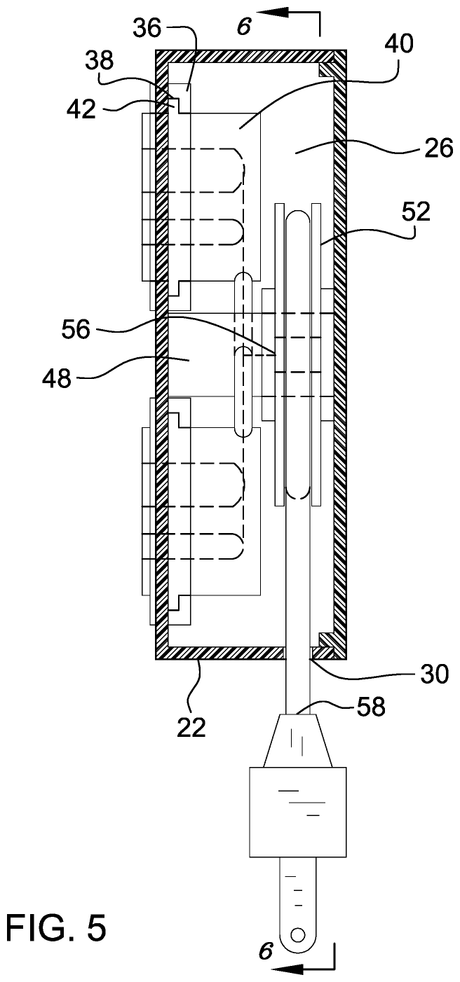

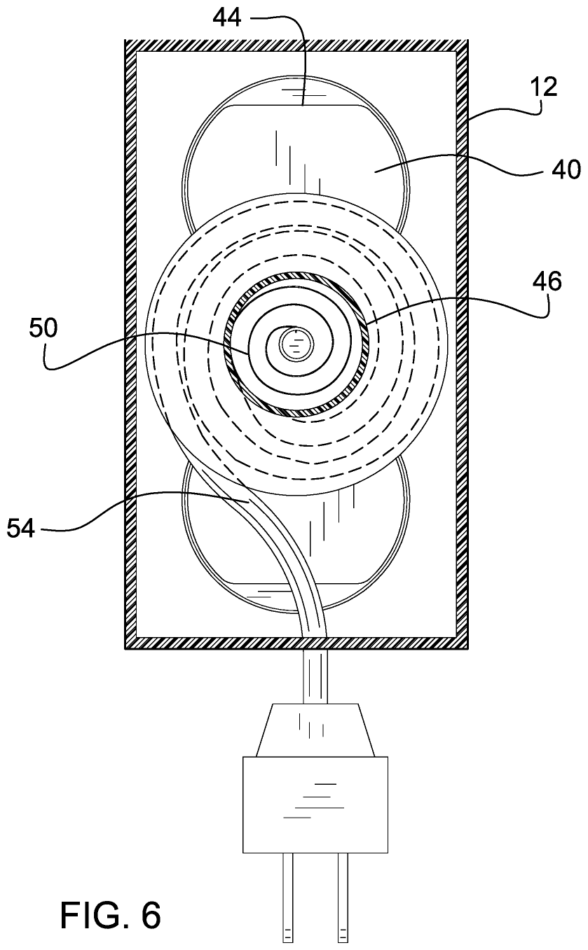

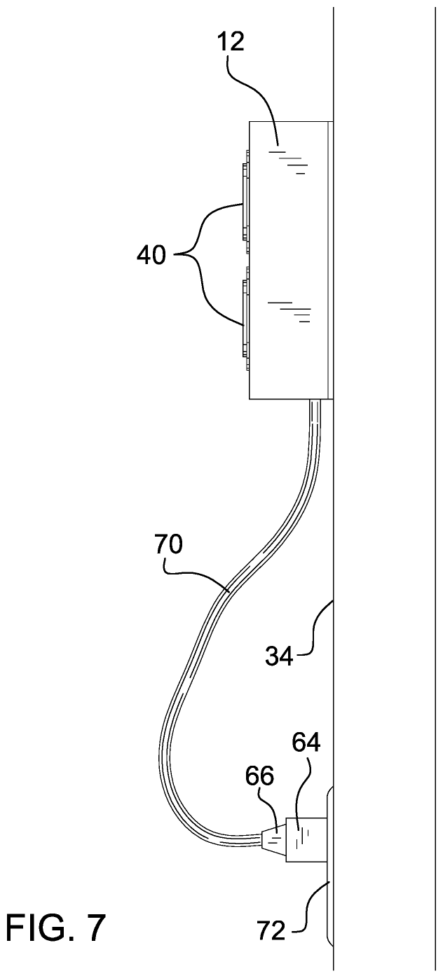

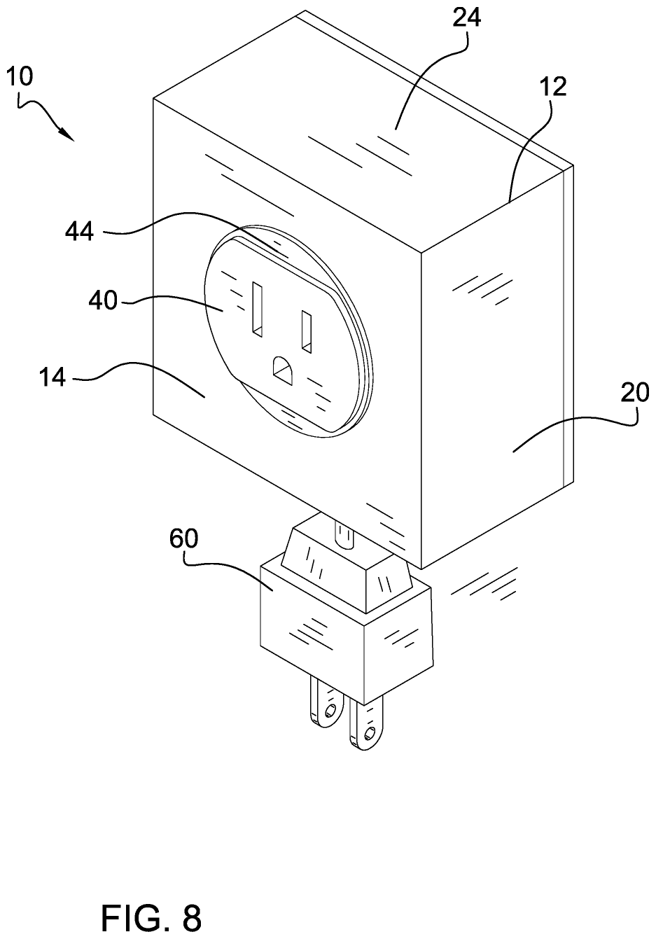

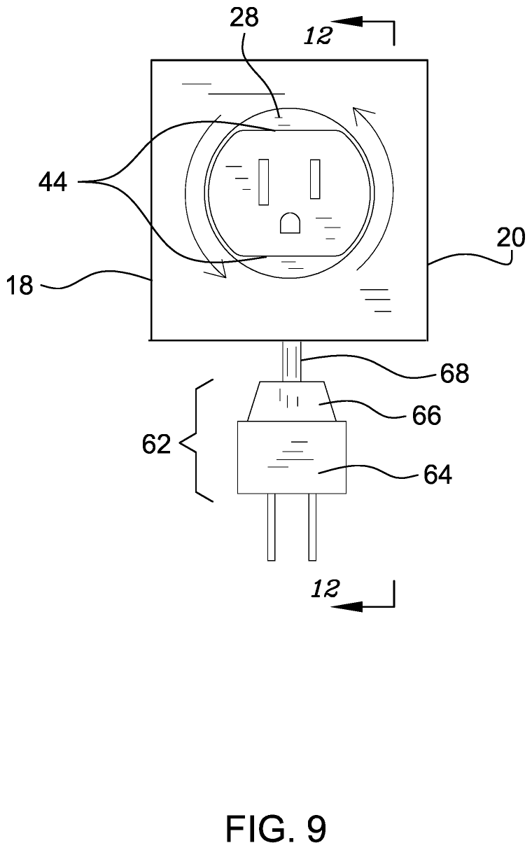

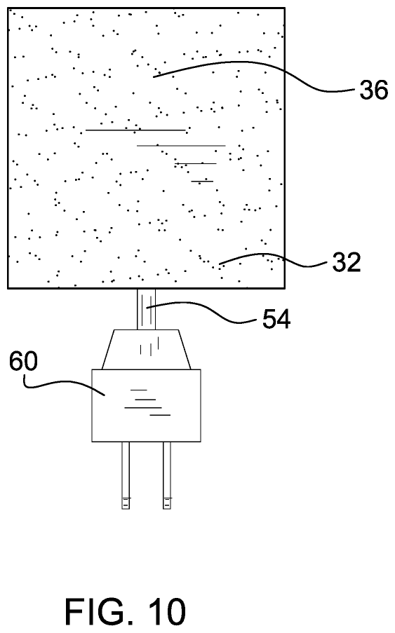

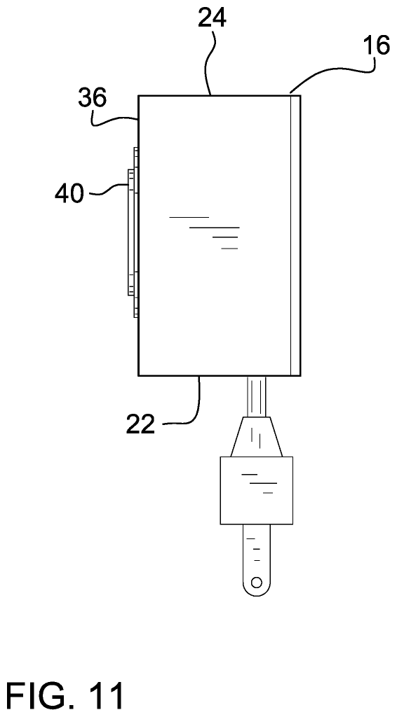

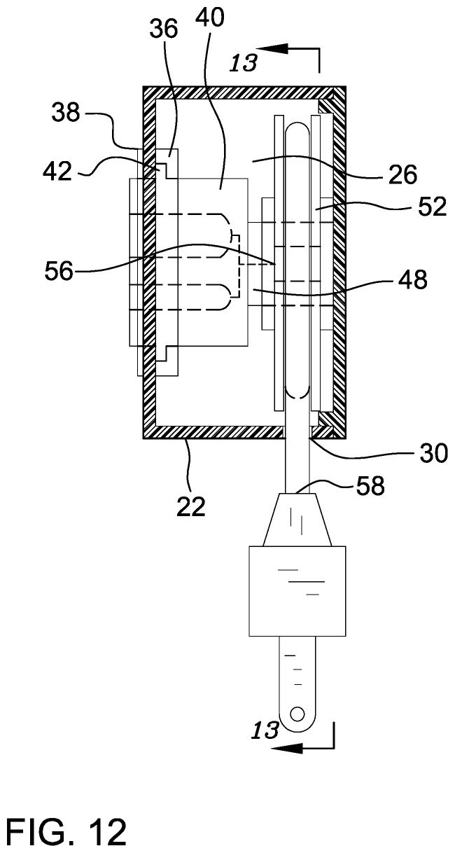

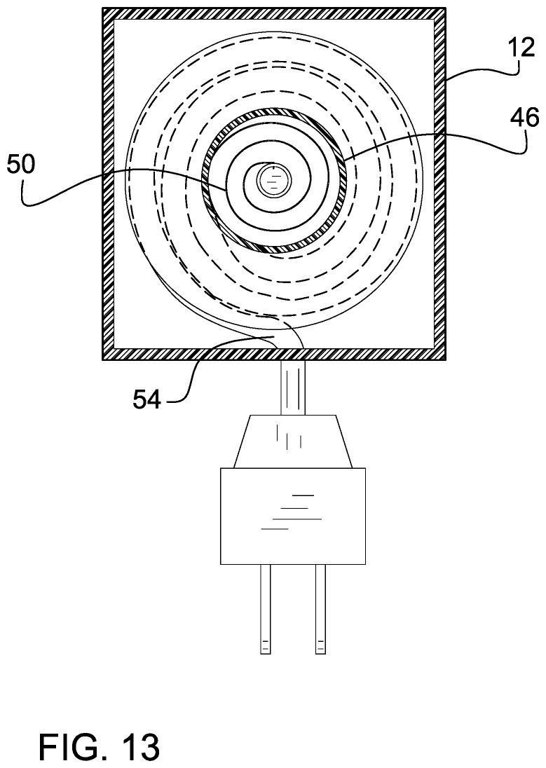

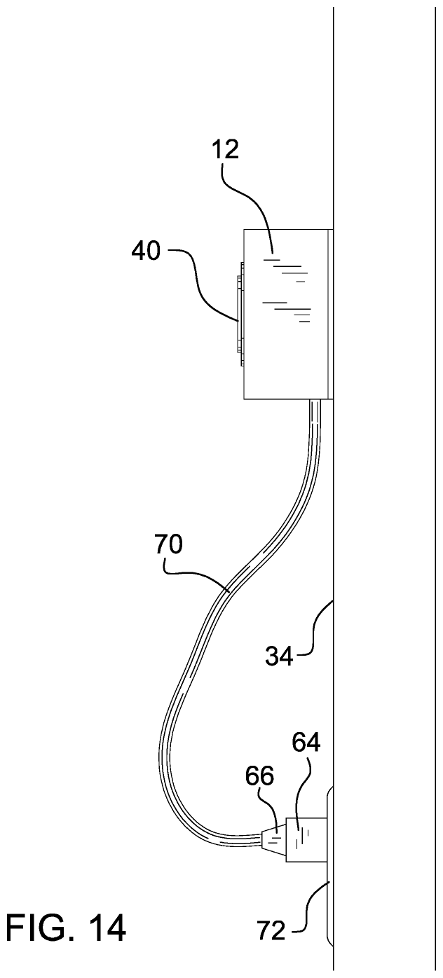

With reference now to the drawings, and in particular to FIGS. 1 through 14 thereof, a new power extension embodying the principles and concepts of an embodiment of the disclosure and generally designated by the reference numeral 10 will be described.

As best illustrated in FIGS. 1 through 14, the retractable wall outlet extension 10 generally comprises an outlet housing 12 having a front side 14 separated from a rear side 16, a left side 18 separated from a right side 20, and a bottom side 22 separated from a top side 24. The outlet housing has a cavity 26 between the front side, the rear side, the left side, the right side, the bottom side, and the top side. An at least one outlet aperture 28 extends through the front side 14 to the cavity 26 and a cord aperture 30 extends through the bottom side 22 to the cavity. The rear side 16 has a mounting mechanism 32 disposed on the rear side, wherein the mounting mechanism is configured to couple the outlet housing 12 to a wall 34. The mounting mechanism may be an adhesive 36 continuously disposed on the rear side to quickly attach the outlet housing to any desired location.

An at least one outlet track 36 is coupled within the at least one outlet aperture 28. Each of the at least one outlet tracks has a channel 38. An at least one outlet 40 is coupled to the outlet housing, with each of the at least one outlet having a guide ridge 42 rotatably coupled within the outlet track. Each of the at least one outlet thus independently rotates relative the outlet housing. The rotation may be 90° to prevent physical interference between large device plugs. Each of the at least one outlet has a pair of facets 44 to provide a place for a user to grip and rotate the outlet.

A spool assembly 46 is coupled within the cavity 26 of the outlet housing. The spool assembly comprises an axel 48, a tensioner spring 50, and a spool 52. The axel extends from the front side 14 to the rear side 16 of the outlet housing, the spool 52 is rotatably coupled to the axel 48, and the tensioner spring 50 is coupled between the spool and the axel.

An extension cord 54 is coupled within the cavity 26 of the outlet housing. The extension cord has a proximal end 56 and a distal end 58, with the proximal end coupled to each of the at least one outlets 40, the extension cord wound around the spool and through the cord aperture 30 of the bottom side, and the distal end having a plug 60. The plug may have a plug housing 62 comprising a rectangular prismatic portion 64 and a trapezoidal prismatic portion 66. The trapezoidal prismatic portion is coupled to the rectangular prismatic portion to secure the extension cord 54 and prevent damage to the wiring of the plug 60. The extension cord has a wound position 68 on the spool with the plug proximal the outlet housing 12 and an alternate extended position 70 with the extension cord extended through the cord aperture 30.

In use, the extension cord 54 is manually extended from the wound position 68 to the alternate extended position 70 by the user pulling on the distal end 58 and unwinding the spool 52, with the spool loading the tensioner spring 50 as it unwinds. The plug 60 is inserted into a wall outlet 72, providing power to the at least one outlet 40. The outlet housing 12 is then mounted to the wall using the mounting mechanism 32 in a chosen location to provide more convenient access to power. To be stored, the outlet housing is removed from the wall 34 and the plug 60 is unplugged from the wall outlet 72. The user then tugs on the extension cord 54 to release the tensioner spring 50, returning the extension cord from the extended position 70 to the wound position 68 under the power of the tensioner spring.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A retractable wall outlet extension comprising:
an outlet housing having a front side separated from a rear side, a left side separated from a right side, and a bottom side separated from a top side, the outlet housing having a cavity between the front side, the rear side, the left side, the right side, the bottom side, and the top side, the outlet housing having an at least one outlet aperture extending through the front side to the cavity and a cord aperture extending through the bottom side to the cavity, the rear side of the outlet housing having a mounting mechanism wherein the mounting mechanism is configured to couple the outlet housing to a wall, the mounting mechanism being an adhesive continuously disposed on the rear side;
an at least one outlet coupled to the outlet housing, the at least one outlet being coupled within the at least one outlet aperture;
a spool assembly coupled within the cavity of the outlet housing, the spool assembly comprising an axel, a tensioner spring, and a spool, the axel extending from the front side to the rear side of the outlet housing, the spool being rotatably coupled to the axel, the tensioner spring being coupled between the spool and the axel; and
an extension cord coupled within the cavity of the outlet housing, the extension cord having a proximal end and a distal end, the proximal end being coupled to each of the at least one outlets, the extension cord being windingly coupled around the spool and through the cord aperture of the bottom side, the distal end having a plug, the extension cord having a wound position on the spool with the plug proximal the outlet housing and an alternate extended position with the extension cord extended through the cord aperture, wherein the cord is manually extended from the wound position to the alternate extended position by a user pulling on the distal end and unwinding the spool, the spool loading the tensioner spring as it unwinds, the extension cord returning from the extended position to the wound position under the power of the tensioner spring.

2. The retractable wall outlet extension of claim 1, further comprising an at least one outlet track coupled within the at least one outlet aperture, each of the at least one outlet tracks having a channel, the at least one outlet having a guide ridge rotatably coupled within the outlet track, each of the at least one outlet thus independently rotating relative the outlet housing.

3. The retractable wall outlet extension of claim 2, further comprising each of the at least one outlet having a pair of facets, wherein the pair of facets is configured to provide a place for the user to grip and rotate the outlet.

4. (canceled)

5. (canceled)

6. The retractable wall outlet extension of claim 1, further comprising the plug having a plug housing comprising a rectangular prismatic portion and a trapezoidal prismatic portion, the trapezoidal prismatic portion being coupled to the rectangular prismatic portion to secure the extension cord.

7. A retractable wall outlet extension comprising:
an outlet housing having a front side separated from a rear side, a left side separated from a right side, and a bottom side separated from a top side, the outlet housing having a cavity between the front side, the rear side, the left side, the right side, the bottom side, and the top side, the outlet housing having an at least one outlet aperture extending through the front side to the cavity and a cord aperture extending through the bottom side to the cavity, the rear side having an adhesive mounting mechanism continuously disposed on the rear side, wherein the mounting mechanism is configured to couple the outlet housing to a wall;
an at least one outlet track coupled within the at least one outlet aperture, each of the at least one outlet tracks having a channel;
an at least one outlet coupled to the outlet housing, each of the at least one outlet having a guide ridge rotatably coupled within the outlet track, each of the at least one outlet thus independently rotating relative the outlet housing, each of the at least one outlet having a pair of facets, wherein the pair of facets is configured to provide a place for a user to grip and rotate the outlet;
a spool assembly coupled within the cavity of the outlet housing, the spool assembly comprising an axel, a tensioner spring, and a spool, the axel extending from the front side to the rear side of the outlet housing, the spool being rotatably coupled to the axel, the tensioner spring being coupled between the spool and the axel; and
an extension cord coupled within the cavity of the outlet housing, the extension cord having a proximal end and a distal end, the proximal end being coupled to each of the at least one outlets, the extension cord being windingly coupled around the spool and through the cord aperture of the bottom side, the distal end having a plug, the plug having a plug housing comprising a rectangular prismatic portion and a trapezoidal prismatic portion, the trapezoidal prismatic portion being coupled to the rectangular prismatic portion to secure the extension cord, the extension cord having a wound position on the spool with the plug proximal the outlet housing and an alternate extended position with the extension cord extended through the cord aperture, wherein the cord is manually extended from the wound position to the alternate extended position by the user pulling on the distal end and unwinding the spool, the spool loading the tensioner spring as it unwinds, the extension cord returning from the extended position to the wound position under the power of the tensioner spring.
